(19) United States
(12) Patent Application Publication
(10) Pub. No.: US 2007/0127268 A1
(43) Pub. Date: Jun. 7, 2007

(54) EDGE-TYPE BACKLIGHT MODULE

(76) Inventor: HAN-JUNG CHEN, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/550,787

(22) Filed: Oct. 18, 2006

(30) Foreign Application Priority Data
Dec. 6, 2005 (TW) 094142960

(51) Int. Cl. F21V 7/04

(52) U.S. Cl. 362/630

(57) ABSTRACT

An edge-type backlight module includes a light source and a light guide plate having a lateral side. The light source is installed on the lateral side of the light guide plate. The light guide plate includes a first and a second prism structure for scattering the light emitting out of the light guide plate. The first prism structure includes a first light exit plane and a second light exit plane. A first angle is formed between the first light exit plane and the second light exit plane. The second prism structure includes a third light exit plane and a fourth light exit plane. A second angle is formed between the third light exit plane and the fourth light exit plane. The first angle is different from the second angle.

### BACKGROUND OF THE INVENTION

1. Field of the Invention

The present invention relates to a backlight module, and more particularly, to an edge-type backlight module.

2. Description of the Prior Art

Backlight modules, which are key elements in the fabrication of liquid crystal displays (LCDs), are widely used in monitors, notebook computers, digital cameras, projectors, and so on. Backlight modules are typically divided into two major categories: edge-type and direct-type. A light source of an edge-type backlight module is positioned on the lateral side of the display panel so as to reduce the size and cost of the liquid crystal display.

Please refer to FIG. 1. FIG. 1 is a diagram of a conventional edge-type backlight module 10 in the prior art. The edge-type backlight module 10 includes a light guide plate 14 installed below a display panel 12, a plurality of light emitting diodes (LEDs) 16 installed on a lateral side of the light guide plate 14, an LED cover 18 installed outside the LEDs 16, a reflective sheet 20 installed below the light guide plate 14 for reflecting light emitted through the light guide plate 14 downward back to the light guide plate 14, and an optical material layer 22 installed between the light guide plate 14 and the display panel 12. The LEDs 16 emit light to the display panel 12, and the LED cover 18 and the reflective sheet 20 reflect the light emitted from the LEDs 16 to the light guide plate 14 so as to increase a lighting efficiency. Micro-scattering points (not shown) positioned on the bottom of the light guide plate 14 interfere with the total reflection of light inside the light guide plate 14, so that the light is refracted outside the light guide plate 14 and into the optical material layer 22. The optical material layer 22 mists and converges the light refracted from the light guide plate 14 for providing light to the display panel 12.

As described above, the light guide plate 14 is one of the important parts of the edge-type backlight module 10. The light guide plate 14 guides the light uniformly in order to increase the luminance of the display panel 12 and to ensure the uniformity of brightness in the display panel 12. Please refer to FIG. 2 and FIG. 3. The light guide plate 14 includes a light exit plane 24 formed of a plurality of linear prism structures 26 side by side. The prism angles of the linear prism structures 26 are the same, that is, the angles of V-shaped grooves are the same. As shown in FIG. 3, the angles Ai, Bi, Aj, Bj are equivalent and the angles Ci, Di, Cj, Dj are equivalent. After the light enters into the light guide plate 14, a bottom surface 28 of the light guide plate 14 interferes with the total reflection of the light inside the light guide plate 14 so that the light diffuses to the linear prism structures 26 and is refracted or reflected by the linear prism structures 26. The light is concentrated within a range of a view angle so as to provide light of enhanced luminance to the display panel 12.

After the light emitted from the LEDs 16 enters the light guide plate 14, the light is diffused in a longitudinal direction (direction X) and exited out of the light exit plane 24, so that the light guide plate 14 is illuminated. Furthermore, the light is diffused in a lateral direction (direction Y) and exited out of the light exit plane 24, but a position far away from the LED 16 is darker than a position close to the LED 16, so that the light is concentrated nearby the LED 16 on the display panel 12. Generally speaking, there are several solutions for the above-mentioned problem. A pattern (i.e., surface roughening or dotting) is formed on the patterned metal film by a sand blasting method or an etching method, and light uniformity is achieved by adjusting spacing of the pattern. However, the effect is limited. In addition, the longitudinal length of the light guide plate 14 is increased so as to cover the light-concentrating area nearby the LEDs 16 on the display panel 12. However, this increases the size of the edge-type backlight module 10. Therefore, it is necessary to find an effective solution to solve the above-mentioned problem.

### SUMMARY OF THE INVENTION

It is therefore a primary objective of the claimed invention to provide an edge-type backlight module including a light guide plate with different prism angles of prism structures located in different positions relative to a light source for solving the above-mentioned problem.

To achieve the above-mentioned objective, the present invention provides an edge-type backlight module including a light source and a light guide plate. The light source emits light. The light guide plate has a lateral side. The light source is installed on the lateral side of the light guide plate. The light guide plate includes a first and a second prism structure for scattering the light emitting out of the light guide plate. The first prism structure includes a first light exit plane and a second light exit plane. A first angle is formed between the first light exit plane and the second light exit plane. The second prism structure includes a third light exit plane and a fourth light exit plane. A second angle is formed between the third light exit plane and the fourth light exit plane. The first angle is different from the second angle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional edge-type backlight module.

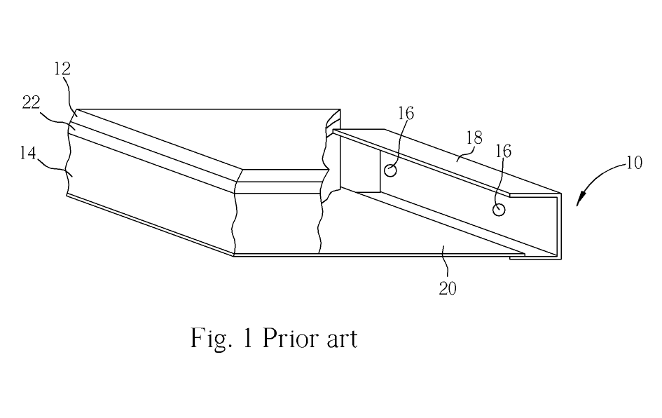

FIG. 2 is a diagram of a conventional light guide plate.

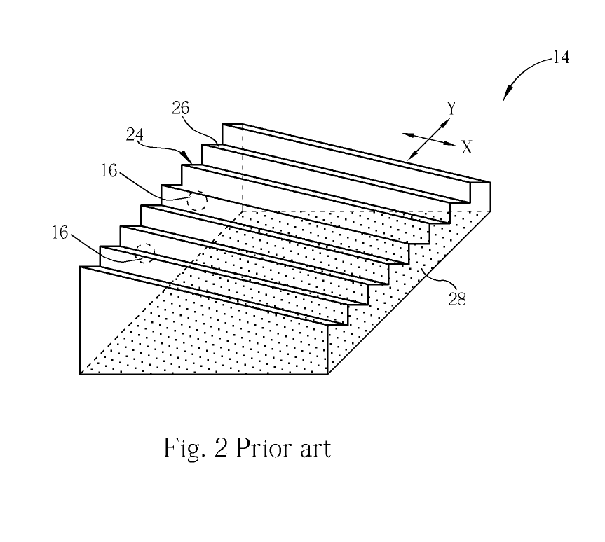

FIG. 3 is a lateral view of the light guide plate shown in FIG. 2.

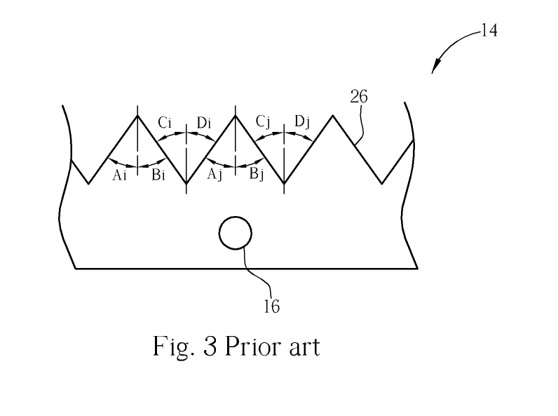

FIG. 4 is a diagram of an edge-type backlight module according to the present invention.

FIG. 5 is a diagram of a light guide plate according to the present invention.

FIG. 6 is a lateral view of the light guide plate shown in FIG. 5 according to the present invention.

FIG. 7 is a diagram of light routes at different prism angles.

FIG. 8 is a diagram of light diffusing in the lateral direction (direction Y) according to the present invention.

### DETAILED DESCRIPTION

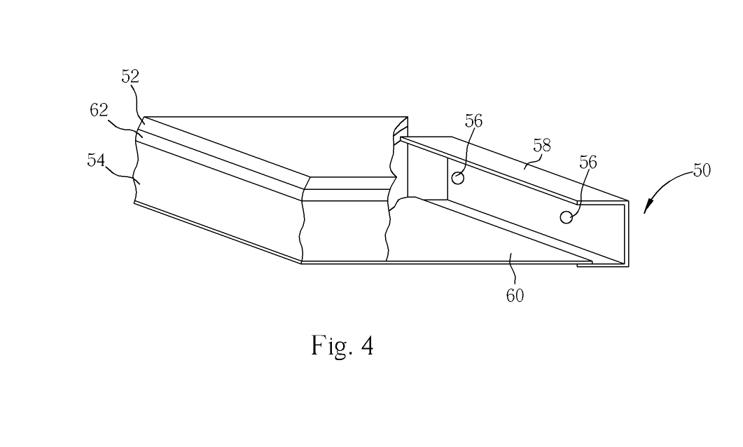

Please refer to FIG. 4. An edge-type backlight module 50 according to the present invention includes a light guide plate 54 installed below a display panel 52. The light guide plate 54 can be made of acrylic. The edge-type backlight module 50 further includes a plurality of light sources 56, such as light emitting diodes (LEDs), installed on a lateral side of the light guide plate 54, a light cover 58 installed outside the light sources 56, a reflective sheet 60 installed below the light guide plate 54 for reflecting light emitted downward through the light guide plate 54 back to the light guide plate 54, and an optical material layer 62 installed between the light guide plate 54 and the display panel 52. The light sources 56 emit light to the display panel 52, and the light cover 58 and the reflective sheet 60 reflect the light emitted from the light sources 56 to the light guide plate 54 so as to increase lighting efficiency. Micro-scattering points (not shown) positioned on the bottom of the light guide plate 54 interfere with the total reflection of light inside the light guide plate 54, so that the light is refracted outside the light guide plate 54 and into the optical material layer 62. The optical material layer 62 further scatters the light refracted from the light guide plate 54 for providing light to the display panel 52.

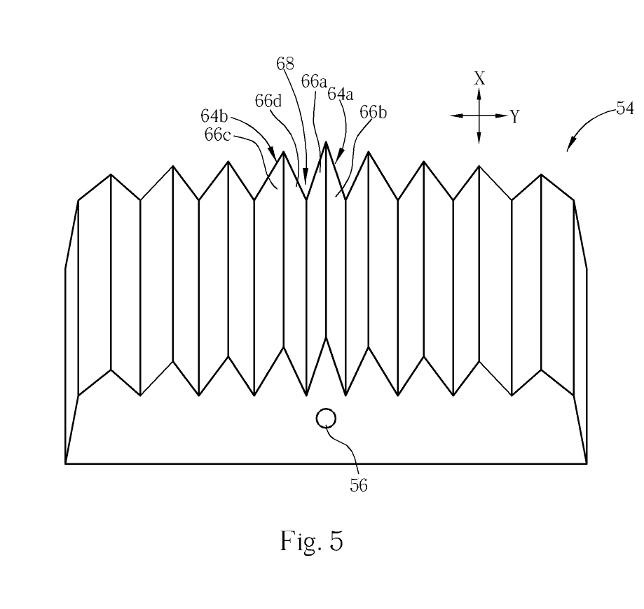

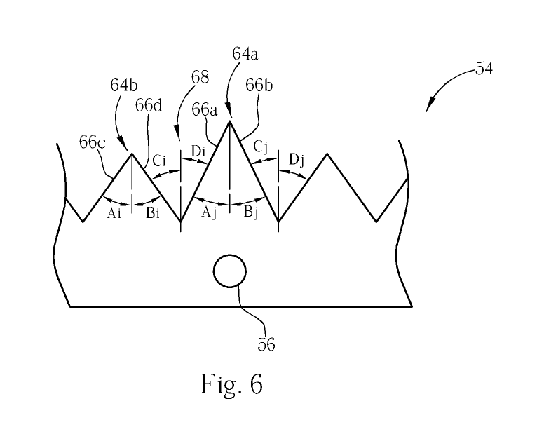

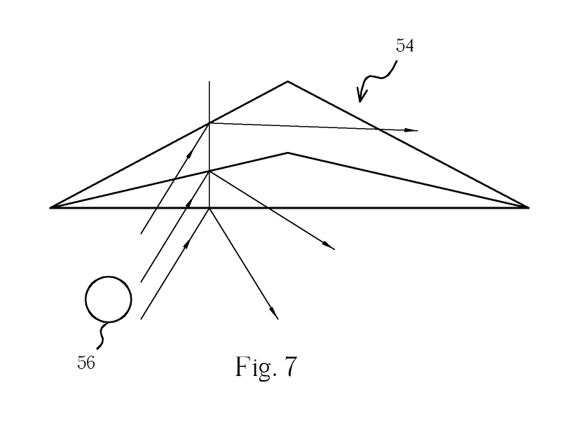

Please refer to FIG. 5 and FIG. 6. The light exit plane of the light guide plate 54 includes a plurality of linear prism structures side by side. After the light enters into the light guide plate 54, a bottom surface of the light guide plate 54 diffusely reflects the light to the linear prism structures, and the light is then refracted or reflected by the linear prism structures. The light is concentrated within a range of a view angle so as to provide light with enhanced luminance to the display panel 52. The linear prism structures of the light guide plate 54 includes a first prism structure 64a and a second prism structure 64b for scattering the light emitting from the light source 56 to emit out of the light guide plate 54. The first prism structure 64a includes a first light exit plane 66a and a second light exit plane 66b. The second prism structure 64b includes a third light exit plane 66c and a fourth light exit plane 66d. A V-groove 68 is formed between the first prism structure 64a and the second prism structure 64b. The first and second light exit plane 66a, 66b of the first prism structure 64a and the third and fourth light exit plane 66c, 66d of the second prism structure 64b respectively make an angle with respect to a direction perpendicular to the light guide plate 54, which are referred as Aj, Bj, Ai, Bi respectively. The angles Aj, Bj of the first prism structure 64a are equivalent, and the angles Ai, Bi of the second prism structure 64b are equivalent. The angles Ai, Bi are greater than the angles Aj, Bj. The angle Cj is equal to the angle Di, and the angle Ci is equal to the angle Dj. The angles Ci, Dj are greater than the angles Cj, Di. The angle Aj and the angle Di are equivalent angles. The angle Bj and the angle Cj are equivalent angles. The angle Bi and the angle Ci are equivalent angles. The prism angle of the first prism structure 64a close to the light source 56 (the angle between the first light exit plane 66a and the second light exit plane 66b, Aj+Bj), referred as a first angle, is less than the prism angle of the second prism structure 64b far away from the light source 56 (the angle between the third light exit plane 66c and the fourth light exit plane 66d, Ai+Bi), referred as a second angle. It is easy for light to be diffused in the lateral direction (direction Y) with a small prism angle. Please refer to FIG. 7, which is a diagram of light routes at different prism angles. When the prism angle is greater, the reflection angle of the light is smaller. When the prism angle is smaller, the reflection angle of the light is greater, so that the light is spread wider.

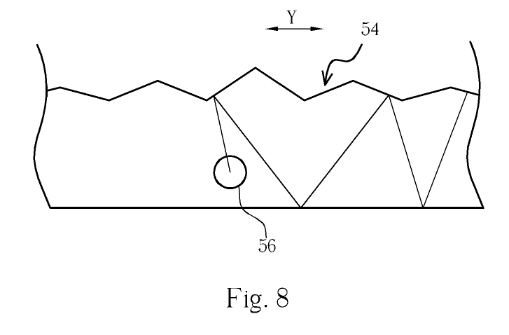

Please refer to FIG. 8. FIG. 8 is a diagram of the light diffusing in the lateral direction (direction Y) according to the present invention. Because the prism angle of the prism structure close to the light source 56 is smaller than the prism angle of the prism structure far away from the light source 56, the prism structure close to the light source 56 has a better light-diffusing effect in the lateral direction (direction Y) than that far away from the light source 56. The light emitting from the light source 56 is diffused in the lateral direction (direction Y) effectively according to the present invention so as to prevent light from concentrating nearby the light source 56 on the display panel. The prism angle of the prism structure nearby each of two lateral ends of the light guide plate is designed to be greater so as to prevent light from diffusing in the lateral direction continuously.

In contrast to the conventional edge-type backlight module, the edge-type backlight module of the present invention utilizes a light guide plate having prism structures with different prism angles according to the positions relative to the light source. That is, the prism angle of the prism structure close to the light source is smaller than the prism angle of the prism structure far away from the light source, so that the light emitting from the light source is diffused to lateral sides of the light guide plate effectively so as to prevent light from concentrating nearby the light source on the display panel. The prism angle of the prism structure nearby each of two lateral ends of the light guide plate is designed to be greater so as to prevent light from diffusing continuously. The present invention improves the light uniformity and light luminance of the edge-type backlight module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An edge-type backlight module comprising:
a light source for emitting light; and
a light guide plate having a lateral side, the light source being installed on the lateral side, the light guide plate comprising:
a first prism structure for scattering the light emitting out of the light guide plate, the first prism structure comprising a first light exit plane and a second light exit plane, a first angle being formed between the first light exit plane and the second light exit plane; and
a second prism structure for scattering the light emitting out of the light guide plate, the second prism structure comprising a third light exit plane and a fourth light exit plane, a second angle being formed between the third light exit plane and the fourth light exit plane, and the first angle being different from the second angle.

2. The edge-type backlight module of claim 1, wherein the first prism structure and the second prism structure are linear prism structures.

3. The edge-type backlight module of claim 2, wherein a V-groove is formed between the first prism structure and the second prism structure.

4. The edge-type backlight module of claim 1, wherein the first prism structure is closer to the light source than the second prism structure is, and the second angle is greater than the first angle.

5. The edge-type backlight module of claim 1, wherein the light source is a light emitting diode (LED).

6. The edge-type backlight module of claim 1, wherein the light guide plate is made of acrylic.

7. The edge-type backlight module of claim 1, further comprising an optical layer installed above the light guide plate for scattering the light refracted from the first prism structure and the second prism structure of the light guide plate.
